(19) United States
(12) Patent Application Publication
(10) Pub. No.: US 2026/0289251 A1
(43) Pub. Date: Sep. 24, 2026

(54) TASK COMPLETION USING A LANGUAGE MODEL NEURAL NETWORK

(71) Applicant: Google LLC, Mountain View, CA (US)

(72) Inventors: Omar Abdelaziz, Santa Clara, CA (US); Martin Baeuml, Hedingen (CH)

(21) Appl. No.: 19/474,033

(22) PCT Filed: Apr. 11, 2023
(86) PCT No.: PCT/US2023/018197

§ 371 Date: Oct. 9, 2025

(51) Int. Cl. G06N 3/0475; G06N 3/088

(52) U.S. Cl. CPC G06N 3/0475; G06N 3/088

(57) ABSTRACT

Methods, systems, and apparatus, including computer programs encoded on a computer storage medium, for automating the interaction with user interfaces for task execution using a language model neural network. In one aspect, a method comprises receiving an input that describes a task; determining data describing the task; and executing the task by using a language model neural network by repeatedly performing following operations: obtaining a first input subsequence that is derived from the data describing the task; obtaining a second input subsequence that is derived from an image of a current user interface; generating, by the language model neural network, based on the first input subsequence and the second input subsequence, output data that describes one or more actions to be performed within the current user interface; and performing the one or more actions within the current user interface.

### BACKGROUND

Automated assistants (also known as “personal assistant modules” or “mobile assistants”) may be interacted with by a user via a variety of computing devices, such as smart phones, tablet computers, wearable devices, automobile systems, standalone personal assistant devices, and so forth. The automated assistants receive input from the user (e.g., typed or spoken natural language input) and respond with responsive content (e.g., visual and/or audible natural language output). An automated assistant may provide a broad range of functionalities through interactions with various local and/or third-party applications, websites, or other agents.

Some functionalities of the automated assistant may be implemented by using neural networks. Neural networks are machine learning models that employ one or more layers of nonlinear units to predict an output for a received input. Some neural networks include one or more hidden layers in addition to an output layer. The output of each hidden layer is used as input to the next layer in the network, i.e., another hidden layer or the output layer. Each layer of the network generates an output from a received input in accordance with current values of a respective set of parameters.

### SUMMARY

This specification describes a system implemented as computer programs on one or more computers in one or more locations that allows interaction with user interfaces for task execution to be automated by executing actions defined in output sequences generated by a language model neural network. Each output sequence can define one or more actions that once performed will cause a current user interface to progress into subsequent user interface(s) toward accomplishing a task.

In general, one innovative aspect of the subject matter described in this specification can be embodied in methods that include the actions of receiving, at a computing device, an input that describes a task; determining, from the input, data describing the task; and executing the task by the computing device by using a language model neural network, wherein executing the task comprises repeatedly performing following operations until a termination criterion is met: obtaining a first input subsequence that is derived from the data describing the task; obtaining a second input subsequence that is derived from an image of a current user interface displayed on the computing device; generating, by the language model neural network, based on the first input subsequence and the second input subsequence, output data that describes one or more actions to be performed within the current user interface; and causing the current user interface to transition into a successive user interface by performing the one or more actions within the current user interface.

These and other implementations can each optionally include one or more of the following features. In some aspects, the input may include a voice input or a text input from a user of the computing device. In some aspects, obtaining the second input subsequence may include using one or more of an optical character recognition (OCR) engine, a trained text extraction neural network, or a trained image embedding neural network. In some aspects, the current user interface may display a webpage or a portion of the webpage. In some aspects, the current user interface may display an application view of an application installed on the computing device. In some aspects, the one or more actions may include one or more actions performed by the computing device that simulate a voice input, a keyboard or mouse input, a touchscreen input, a motion input, or a gesture input from the user of the computing device. In some aspects, determining the output data may further include processing by language model neural network a third input subsequence derived from history data that specifies a previous action performed by the computing device within a previous user interface displayed on the computing device. In some aspects, the method may further include providing for display on the computing device a result of executing the task in response to receiving the input. In some aspects, the language model neural network may have been trained on training sequences generated from user interaction with the computing device, and wherein the training may include updating parameter values of the language model neural network to minimize a loss function that evaluates, for each training sequence, a difference between (i) an action described in training output data determined by the language model neural network from processing the training sequence and (ii) an actual action performed by the user on the computing device.

Other implementations of this and other aspects include corresponding systems and computer programs configured to perform the actions of the methods encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The subject matter described in this specification can be implemented in particular embodiments so as to realize one or more of the following advantages. The described techniques allow interaction with user interfaces to be simplified. Rather than having to interact with a user interface of a mobile computing device to execute a task, e.g., on a website or in an application, by iteratively providing commands one after another via appropriate interface elements, such as entering information in text entry fields, selecting particular input buttons, or the like, the described techniques can automate execution of the task by employing a language model neural network that is configured to generate, based on input data derived from images of the user interface, output data that describes a sequence of actions that once executed accordingly can result in successful execution of the task, e.g., can achieve a user specified goal for the task.

The described techniques are not only scalable across multiple computing devices but also compatible with any of a variety of task environments. Because the language model neural network does not rely on any public application programming interface (API), executing tasks even in private applications, legacy applications, or other applications that do not have public APIs can be automated. Moreover, by performing actions guided by the output data of the language model neural network, executing computer executable instructions defined in command scripts that would otherwise be required to automate task execution is no longer needed. Thus, the cost associated with the human intellect that would be required to create command scripts (e.g., to write the scripts, to debug the scripts, to maintain the scripts, etc.) is lowered; the cost associated with the computing resources (e.g., memory and computing power) that would be required to prepare the command scripts for running is also reduced.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example task execution system.

FIG. 2 is an illustration of example tasks that may be requested by a user for an automated assistant to perform.

FIG. 3 is an illustration of an automated assistant performing a task requested by a user.

FIG. 4 is a flow diagram of an example process for executing a task by using a language model neural network.

Like reference numbers and designations in the various drawings indicate like elements.

### DETAILED DESCRIPTION

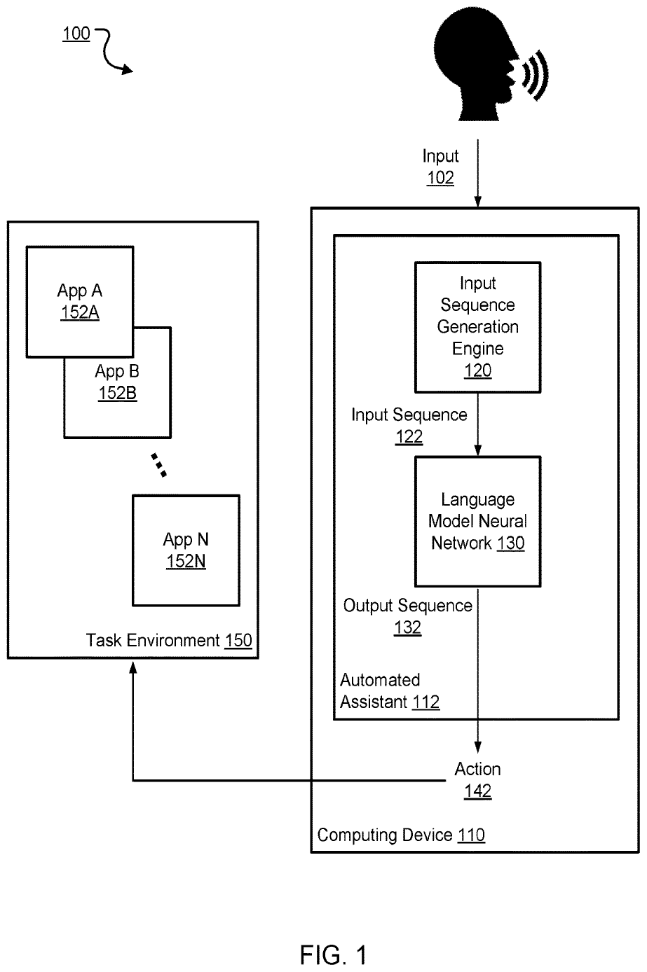

FIG. 1 is a diagram of an example task execution system 100. The task execution system 100 is an example of a system implemented as computer programs on one or more computers in one or more locations, in which the systems, components, and techniques described below can be implemented.

The task execution system 100 includes a computing device 110. The computing device 110 can be, for example, a desktop computer, laptop computer, a tablet computer, a wearable computer, a cellular phone, a smart phone, a music player, an e-book reader, a navigation system, or any other appropriate electronic device. The computing device 110 includes a display that enables presentation of a user interface. The computing device 110 also includes one or more input devices that facilitate user input 102 such as a keyboard, a mouse, a voice-command input unit or microphone, a touch screen display, a touch-sensitive input pad, a gesture capturing camera, or other input buttons or controls.

User interface provides an interface between a user and the computing device 110. Generally a user interface refers to the information (such as graphic, text, and sound) an application running on the computing device 110 presents to a user and the control sequences the user may employ to control the application. There are many types of user interfaces. In one example, the user interface may be a graphical user interface (GUI). A GUI is a type of user interface that allows users to interact with the computing device 110 through graphical icons, text inputs, and/or audio indicators.

The computing device 110 includes an automated assistant 112 capable of performing multiple tasks in response to an input 102 from the user. The automated assistant 112 can be an application that operates at the computing device 110 and/or a remote device, e.g., a cloud server, which is connected to the computing device 110 over a data communication network, e.g., Internet. The automated assistant 112 can receive textual, audio, or other types of inputs 102 from the computing device 110 and interpret the inputs for performing actions 142 to assist the user.

In particular, the automated assistant 112 uses an input sequence generation engine 120 and a language model neural network 130 to parse an input 102 from a user that describes a task to determine what actions 142 are needed in order for the task that the user is requesting to be performed. Each action for the task can be associated with an application that can execute action and/or provide information for executing a separate action. Depending on task described in the input 102 from the user, the actions can be performed in serial, parallel, or a combination thereof.

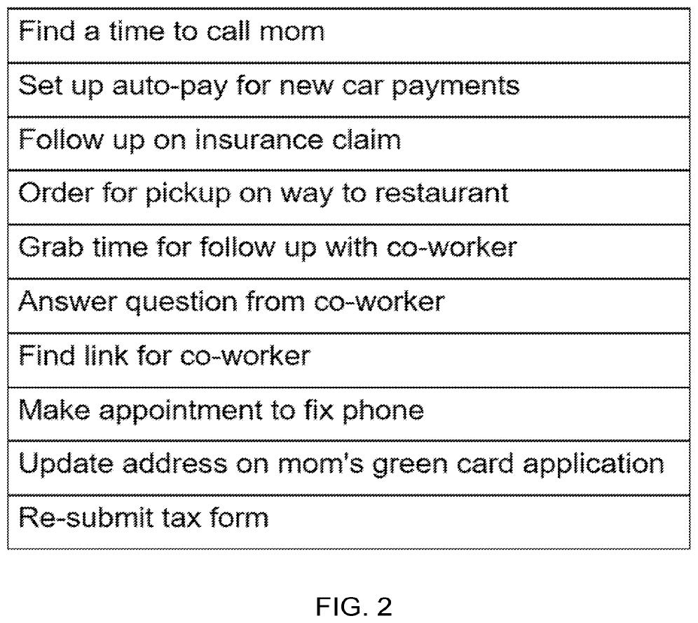

FIG. 2 is an illustration of example tasks that may be requested by a user for an automated assistant 112 to perform. In the example of FIG. 2, the user can request that the automated assistant 112 find a time to call their family member, order food at a restaurant, retrieve specific documents, and so on by speaking or typing an input 102 such as, for example, “Assistant, find a time to call my mom.”

In the situations of these tasks and many other situations, a large quantity of actions may be required to be performed in a task environment 150 for the automated assistant to eventually perform a particular task. Performance of the actions determined by the automated assistant 112 generally causes the task environment 150 to transition into successive new states. Throughout this specification, the task environment 150 can refer to a suitable execution environment, e.g., a runtime environment or an operating system environment, in which one or more applications software, e.g., apps A-N 152A-N, that are installed on the computing device 110, can be executed. An action can refer to any activity or operation that may be performed or initiated by the user within the application. Some examples of actions that can be manually performed and/or initiated by the user include, without limitation, scrolling, clicking on a button, navigating to a search bar, entering text in a text entry field, and so on.

For example, the task environment 150 can include a web browsing application installed on the computing device 110. The web browsing application provides capabilities for accessing websites by the computing device 110. In this example, each state of the task environment 150 can correspond to a webpage, or a portion of a webpage, that is currently displayed on the user interface. In response to an action of scrolling, the webpage is scrolled to reveal an additional portion of the webpage, which can then correspond to a subsequent, new state of the task environment 150. Additionally or alternatively, in response to an action of inputting text into a text entry field on the webpage, the web browsing application fetches and displays on the user interface a new webpage associated with the input text, which can then correspond to a subsequent, new state of the task environment 150. In this example of a web browsing application, executing a particular task, e.g., completing a form on a website or retrieving certain information from a website, involves repeating a lengthy sequence of actions, e.g., click/tap, scroll/swipe, text entry, and so on, one after another over time.

As another example, the task environment 150 can include a food ordering application. The food ordering application provides capabilities for selecting a restaurant, e.g., from restaurants being currently open, and for selecting food items, e.g., from a menu of food items offered by the selected restaurant. Within the food ordering application, the available restaurants and the available food items may be displayed in a list format or in a grid format. In this example, each state of the task environment 150 can correspond to a list or grid, or a portion of the list or grid, that is currently displayed on the user interface. In response to an action of scrolling, the list is scrolled to reveal additional items in the list, which can then correspond to a subsequent, new state of the task environment 150. Additionally or alternatively, in response to an action of selecting a particular item, the food ordering application displays relevant content associated with the selected item, which can then correspond to a subsequent, new state of the task environment 150. Just as the web browsing application example, in this example of a food ordering application, executing a particular task, e.g., placing a food order at a restaurant, involves performing multiple actions one after another over time.

As another example, the task environment 150 can include a calendar application. The calendar application can cause computing device 110 to display, for example, a day view, a month view, or a year view of various calendar entries, where each view can correspond to a respective state of the task environment 150. Just as the web browsing application example and the food ordering application example, in this example of a calendar application, executing a particular task, e.g., determining available hours that the user is free to call their family member, involves performing multiple actions one after another over time.

More generally, any application with a set of views, sometimes also called application views or application windows, in which information is displayed and control elements occur, can define a task environment 150. For example, the task environment 150 can include one or more of a system application (e.g., a home screen application or an application-switcher application), a telephone application, an e-mail application, an instant messaging application, a digital music player application, a digital video player application, and so on.

Referring back to FIG. 1, the input sequence generation engine 120 can generate an input sequence 122 representing a current state of task environment 150 from (i) the input 102 that describes a task and (ii) a current user interface displayed on the computing device 110. The input sequence 122 includes a plurality of data elements. Throughout this specification, a “data element” can refer to, e.g., a numerical value (e.g., an integer or floating point numerical value) or an embedding. An embedding refers to an ordered collection of numerical values, e.g., a vector, matrix, or other tensor of numerical values. Thus, the input sequence 122 can be, e.g., a sequence of numerical values, a sequence of embeddings, or a sequence that includes numerical values in some positions and embeddings in other positions.

The input sequence 122 includes a first input subsequence derived from data describing the task. The data describing the task generally includes text in a natural language. For example, the data describing the task can be the sequence of words “go to ShoeCo.com and buy ShoeCo Runners, size 42.” The first input subsequence thus provides information about the user instructions related to the task to be performed by the automated assistant 112 in the task environment 150.

In some cases, the data describing the task can simply be the input 102 provided by the user, while in other cases, the data describing the task can be a modified version of the input 102. For example, the data describing the task can include some portion of the input 102, but without the other portion that is used by the user to invoke the automated assistant 112, that is irrelevant to the task, or both. As another example, the data describing the task can include some portion of the input 102, and can additionally include relevant information retrieved by the automated assistant 112, e.g., from a local or remote data store, that is needed for the task. Moreover, in cases where the input is spoken by the user, the input sequence generation engine 120 can use a voice to text engine for converting audio inputs into text in the natural language.

The input sequence generation engine 120 can represent the data describing the task as a sequence of data elements that make up the first input subsequence in any appropriate way. For example, the input sequence generation engine 120 can represent the data describing the task as a sequence of tokens from a predefined vocabulary of tokens, and then map each token to a corresponding numerical value in accordance with a predefined mapping. The predefined vocabulary of tokens can include, e.g., one or more of characters, sub-words, words, punctuation marks, numbers, or other symbols that appear in natural language text.

The input sequence 122 also includes a second input subsequence that is generated from an image of a current user interface displayed on the computing device. Throughout this specification, an “image” can refer to a digital image, such as a two-dimensional image or a three-dimensional image, or even consecutive frames of video. Each image may be represented by an array of pixel intensity values. Images may be captured by using an application that facilitates webpage capturing, screen recording, screenshot capturing, or the like. A few example techniques for representing images as sequences of data elements are described in more detail below.

In some implementations, the input sequence generation engine 120 can represent the array of pixel intensity values representing the image as a sequence of numerical values by concatenating each pixel intensity value in the array of pixel intensity values into a sequence of pixel intensity values in a predefined order.

In some implementations, the input sequence generation engine 120 can first use an image to text engine to identify text from the image, and then similarly use the techniques mentioned above to map the identified text into numerical values. For example, the image to text engine can be an optical character recognition (OCR) engine or a trained text extraction neural network.

In some implementations, the input sequence generation engine 120 can use an image embedding neural network to map the image of the currently displayed user interface to an embedding of the image. For example, the image embedding neural network can be an encoder neural network of an auto-encoder machine learning model that has a convolutional neural network architecture.

Optionally, the input sequence 122 further includes a third input subsequence derived from history data that specifies one or more previous actions performed by the computing device 110 within one or more previous user interface displayed on the computing device. In other words, the history data provides information about historical interaction of the automated assistant 112 with the one or more apps 152A-N in the task environment 150. For example, the history data can include natural language text, and the input sequence generation engine 120 can similarly represent the history data as a sequence of tokens and then map each token to a corresponding numerical value in accordance with a predefined mapping.

The language model neural network 130 is configured to process the input sequence 122 to generate an output sequence 132 that describes one or more actions to be performed in the current user interface. The language model neural network 130 is a neural network having a set of parameters that is configured to process an input sequence in accordance with the parameters to generate an output sequence based on the input sequence.

The language model neural network 130 can have any appropriate architecture that allows the neural network 130 to map the input sequence to the output sequence. Examples architectures of the language model neural network as well as techniques for training such a neural network are described in more detail in Thoppilan, Romal, et al. “Lamda: Language models for dialog applications.” arXiv preprint arXiv:2201.08239 (2022) and Adiwardana, Daniel, et al. “Towards a human-like open-domain chatbot.” arXiv preprint arXiv:2001.09977 (2020).

The output sequence 132 can include a respective token from a vocabulary of tokens at each of multiple positions. For example, the vocabulary of tokens can be the same as the vocabulary used when generating the first input subsequence. As discussed above, the vocabulary of tokens can include, e.g., one or more of characters, sub-words, words, punctuation marks, numbers, or other symbols that appear in natural language text.

After generating the output sequence 132 that describes one or more actions 142, the automated assistant 112 causes the computing device 110 to perform, by using an execution engine, the one or more actions 142 within the current state of the task environment 150. In general, the one or more actions include activities or operations performed by the execution engine of the computing device 110 that simulate a voice input, a keyboard or mouse input, a touchscreen input, a motion input, a gesture input, or the like from the user of the computing device 110. For example, such activities or operations performed by the execution engine can include moving a curser, a pointer, or some other indicators to a desired location within the current user interface, performing a click/selection operation at a desired location, entering desired text in a text entry field, and so on. In some implementations, the automated assistant 112 can include a text parser engine that can process the output sequence, or textual data determined from the output sequence, and convert it into instructions for execution by the execution engine of the automated assistant 112 and/or one or more apps 152A-N. In some implementations, the automated assistant 112 can include a neural network that is configured to map high-level natural language instructions to concrete actions for execution by the execution engine of the automated assistant 112 and/or one or more apps 152A-N.

Continuing from the sneaker purchase task example mentioned above, when executing the task requested by the user, the automated assistant 112 uses the input sequence generation engine 120 to generate an input sequence that is in the form of:
<task description>##<screen image>,
   where “<task description>” represents the first input subsequence that includes a sequence of data elements generated from data describing the task, “<screen image>” represents the second input subsequence that includes a sequence of data elements generated from the image of the current user interface displayed on the computing device, and “##” is a predetermined token that separates the first and second input subsequences within the input sequence. Note that the input subsequence need not actually include delimiters “<” and “>”. And it will be appreciated with a different token can also be used as the separation token instead of “##”.

This input sequence is then received and processed by the language model neural network 130 to generate an output sequence that is in the form of:
DO click 200 13 #click to focus the search box.

After causing the computing device 110 to perform the click action at the specified location (coordinates 200, 13) within the user interface, the automated assistant 112 generates another input sequence that is in the form of:
<task description>##<screen image>##<PREV click 200 13>,
   where “<PREV click 200 13>” represents the third input subsequence that includes a sequence of data elements generated from history data that specifies the click action that was previously performed, and “PREV” is a predetermined token that is optionally included as a prefix of the third input subsequence.

This input sequence is then received and processed by the language model neural network 130 to generate another output sequence that is in the form of:
DO enter ShoeCo runners.

After causing the computing device 110 to perform the text entry action to enter the text “ShoeCo runners” within the user interface, the automated assistant 112 generates a further input sequence that is in the form of:

<task description> ## <screen image> ## <PREV
click 200 13> ## <PREV enter ShoeCo
venture runners>,

which is then received and processed by the language model neural network 130 to generate an output sequence that is in the form of:
DO click 200 80 #click on “search”,
   and so on, until reaching the goal state of this task, which in this example may be an order confirmation page on the ShoeCo.com website.

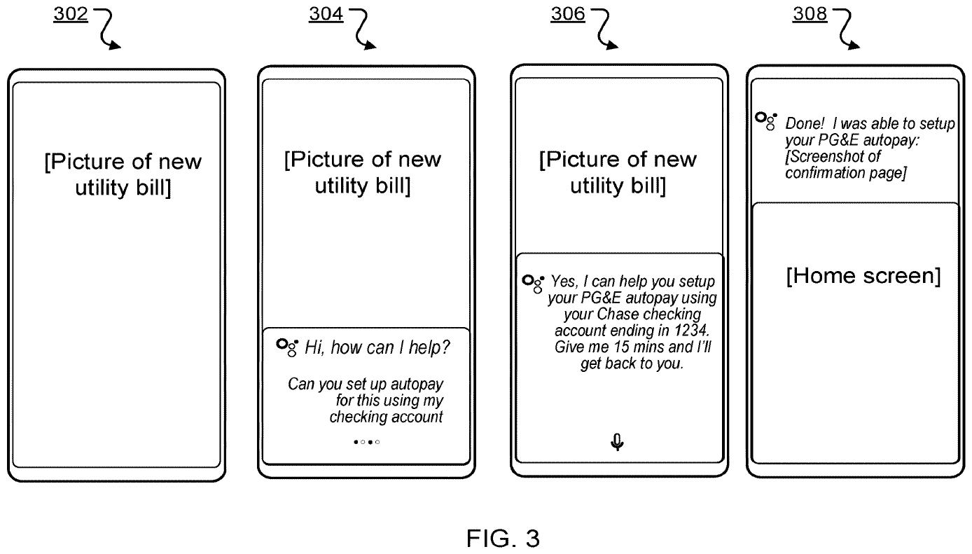

FIG. 3 is an illustration of an automated assistant performing a task requested by a user. As illustrated, requesting the automated assistant 112 to execute the task of setting up automatic payment for utility bills can begin with viewing a picture of a new utility bill (302) and invoking the automated assistant 112 as part of a dialog application (304). As the first dialog turn in the dialog application, the user submitted an input, e.g., in audio or text, that describes the task of setting up automatic payment for utility bills using a checking account of the user. Correspondingly, the automated assistant 112 determines data that describes the task (306), which includes information about the utility bill and the checking account, and then proceeds to perform a sequence of actions guided by the output sequences of the language model neural network 130 to complete the task. Upon completion of the task, the automated assistant 112 provides a result of executing the task in the next dialog turn (308), e.g., by providing for display a screenshot of the confirmation page of successful automatic payment setup.

As can be seen from the example of FIG. 3, automatically executing tasks in this way can avoid a large quantity of dialog turns that would otherwise be needed for the user to eventually get the automated assistant 112 to perform a particular task. This can minimize the waste of time for the user, as well as ensure efficient use of computational resources for the automated assistant 112 because repeatedly processing and responding to each input from the user is no longer needed.

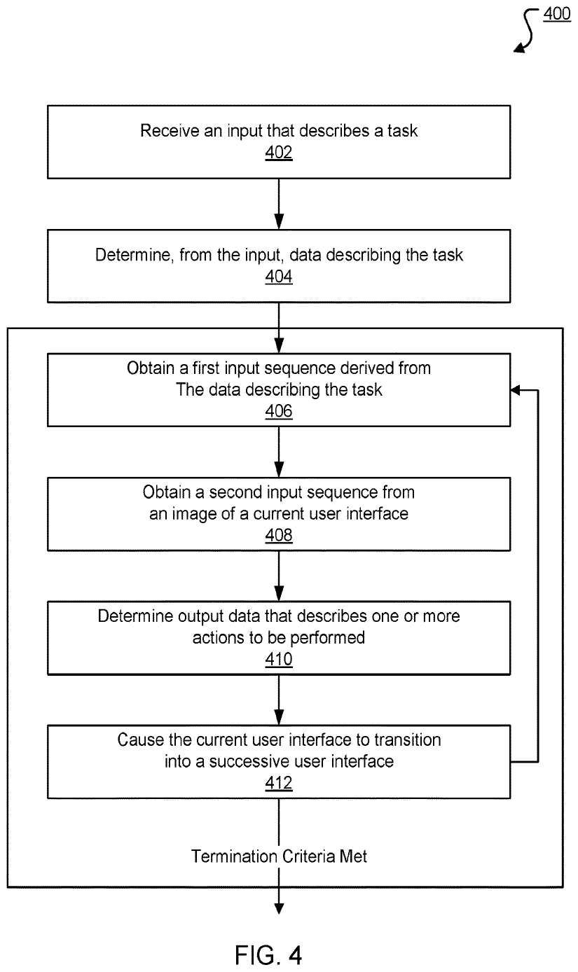

FIG. 4 is a flow diagram of an example process 400 for executing a task by using a language model neural network. For convenience, the process 400 will be described as being performed by a system of one or more computers located in one or more locations. For example, a system, e.g., a system that includes the computing device 110 of FIG. 1, appropriately programmed in accordance with this specification, can perform the process 400.

The system receives, at a computing device, an input that describes a task (step 402). For example, the user can speak or type the input that describes the task, thereby requesting an automated assistant to perform the task.

The system can parse the input from the user and determine data describing the task (step 404). For example, the system can determine what information, e.g., in addition to what is made available in the input from the user, is needed for the task.

The system executes the task by using a language model neural network. Executing the task can include repeatedly performing following steps 406-412 until a termination criterion is met. Different tasks may have different termination criteria. For example, the termination criterion may be that a goal state that is defined in the input or otherwise inferred by the system from the input is achieved in the task environment. As another example, the termination criterion may be that a threshold period of time has elapsed since the input is received.

The system obtains a first input subsequence that is derived from the data describing the task (step 406). The data describing the task can include text in a natural language, and the first input subsequence can include a sequence of data elements generated by the system from the text. Since the first input subsequence remains the same throughout the execution of the task, in some cases the system can reuse the first input subsequence from a prior iteration of steps 406-412 without having to generate a new one.

The system obtains a second input subsequence that is derived from an image of a current user interface displayed on the computing device (step 408). The second input subsequence can include an embedding of the image. Additionally or alternatively, the second input subsequence can include a sequence of data elements generated from text identified from the image.

Optionally, the system obtains a third input subsequence derived from history data that specifies one or more previous actions performed by the computing device within one or more previous user interfaces displayed on the computing device. The history data can include text in a natural language, and the third input subsequence can include a sequence of data elements generated by the system from the text. In some cases the system can generate the third input subsequence by appending the additional data elements generated from the history data that describes the latest, previous action while reusing the data elements included in the third input subsequence from a prior iteration of steps 406-412.

The system generates output data that describes one or more actions to be performed in the current user interface (step 410). In particular, the output data is generated by using the language model neural network. The language model neural network is configured to process an input sequence that includes a combination, e.g., concatenation, of (i) the first input subsequence, (ii) the second input subsequence and, in some cases, (iii) the third input subsequence, in accordance with the parameters to auto-regressively generate an output sequence that includes a respective token from a vocabulary of tokens at each of multiple positions. Such an output sequence describes one or more actions that can be performed within the current user interface, in order to execute the task.

The system causes the current user interface to transition into a successive user interface by performing the one or more actions within the current user interface (step 412). For example, the system can perform an action, e.g., an action that simulates a touchscreen input, with respect to one of the control sequences displayed on the user interface that the user may employ to control an application.

In general, the process 400 can be performed as part of predicting an output sequence for an input sequence for which the desired output sequence, i.e., the output sequence that should be generated by the system for the input sequence, are not known.

The process 400 (or certain steps of the process 40) can also be performed as part of processing input sequences derived from a set of training data, i.e., input sequences derived from a set of inputs for which the output sequences that should be generated by the system are known, in order to train the language model neural network and, in some cases, the image embedding neural network, to determine trained values for the parameters of the language model neural network and the image embedding neural network.

The system, or another system, e.g., a training system that is hosted within a data center, can repeatedly perform steps 406-410 of the process 400 on inputs selected from a set of training data and/or in a simulated task environment that simulates the effects of the actual task environment, as part of a conventional machine learning training technique to train the language model neural network, e.g., a gradient descent with backpropagation training technique that uses a conventional optimizer, e.g., stochastic gradient descent, RMSprop, or Adam optimizer, to optimize an objective function that is appropriate for training the language model neural network. During training, the system can incorporate any number of techniques to improve the speed, the effectiveness, or both of the training process. For example, the system can use data parallelism, model parallelism, or both to increase the speed of the training process.

Moreover, the system can first pre-train the language model neural network on a large unsupervised data set through unsupervised learning, e.g., to minimize a BERT loss or other unsupervised loss, and then fine-tune the language model neural network on training sequences generated from user interaction with the computing device to minimize a fine-tuning objective function suitable for the automated assistant use case. The training sequences can be generated from the captured screenshots of the user interfaces displayed on the computing device. The training sequences can also be generated from records of actions actually performed by a human user on the computing device. The fine-tuning objective function can evaluate, for each training sequence, a difference, e.g., a cross-entropy loss, of the respective data describing (i) an action described in training output data determined by the language model neural network from processing the training sequence, with respect to (ii) an actual action performed by the user on the computing device.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving, at a computing device, an input that describes a task;
determining, from the input, data describing the task; and
executing the task by the computing device by using a language model neural network, wherein executing the task comprises repeatedly performing following operations until a termination criterion is met:
obtaining a first input subsequence that is derived from the data describing the task;
obtaining a second input subsequence that is derived from an image of a current user interface displayed on the computing device;
generating, by the language model neural network, based on the first input subsequence and the second input subsequence, output data that describes one or more actions to be performed within the current user interface; and
causing the current user interface to transition into a successive user interface by performing the one or more actions within the current user interface.

2. The method of claim 1, wherein the input comprises a voice input or a text input from a user of the computing device.

3. The method of claim 1, wherein obtaining the second input subsequence comprises using one or more of an optical character recognition (OCR) engine, a trained text extraction neural network, or a trained image embedding neural network.

4. The method of claim 1, wherein the current user interface displays a webpage or a portion of the webpage.

5. The method of claim 1, wherein the current user interface displays an application view of an application installed on the computing device.

6. The method of claim 4, wherein the one or more actions comprise one or more actions performed by the computing device that simulate a voice input, a keyboard or mouse input, a touchscreen input, a motion input, or a gesture input from the user of the computing device.

7. The method of claim 1, wherein determining the output data further comprises processing by language model neural network a third input subsequence derived from history data that specifies a previous action performed by the computing device within a previous user interface displayed on the computing device.

8. The method of claim 1, further comprising providing for display on the computing device a result of executing the task in response to receiving the input.

9. The method of claim 1, wherein the language model neural network has been trained on training sequences generated from user interaction with the computing device, and wherein the training comprises updating parameter values of the language model neural network to minimize a loss function that evaluates, for each training sequence, a difference between (i) an action described in training output data determined by the language model neural network from processing the training sequence and (ii) an actual action performed by the user on the computing device.

10. A system comprising a computing device and one or more storage devices communicatively coupled to the computing device, wherein the one or more storage devices store instructions that, when executed by the computing device, cause the computing device to perform operations comprising:
receiving, at the computing device, an input that describes a task;
determining, from the input, data describing the task; and
executing the task by the computing device by using a language model neural network, wherein executing the task comprises repeatedly performing following operations until a termination criterion is met:
obtaining a first input subsequence that is derived from the data describing the task;
obtaining a second input subsequence that is derived from an image of a current user interface displayed on the computing device;
generating, by the language model neural network, based on the first input subsequence and the second input subsequence, output data that describes one or more actions to be performed within the current user interface; and
causing the current user interface to transition into a successive user interface by performing the one or more actions within the current user interface.

11. One or more non-transitory computer storage media storing instructions that when executed by a computing device cause the computing device to perform operations comprising:
receiving, at the computing device, an input that describes a task;
determining, from the input, data describing the task; and
executing the task by the computing device by using a language model neural network, wherein executing the task comprises repeatedly performing following operations until a termination criterion is met:
obtaining a first input subsequence that is derived from the data describing the task;
obtaining a second input subsequence that is derived from an image of a current user interface displayed on the computing device;
generating, by the language model neural network, based on the first input subsequence and the second input subsequence, output data that describes one or more actions to be performed within the current user interface; and
causing the current user interface to transition into a successive user interface by performing the one or more actions within the current user interface.

12. The system of claim 10, wherein the input comprises a voice input or a text input from a user of the computing device.

13. The system of claim 10, wherein obtaining the second input subsequence comprises using one or more of an optical character recognition (OCR) engine, a trained text extraction neural network, or a trained image embedding neural network.

14. The system of claim 10, wherein the current user interface displays a webpage or a portion of the webpage.

15. The system of claim 10, wherein the current user interface displays an application view of an application installed on the computing device.

16. The system of claim 14, wherein the one or more actions comprise one or more actions performed by the computing device that simulate a voice input, a keyboard or mouse input, a touchscreen input, a motion input, or a gesture input from the user of the computing device.

17. The system of claim 10, wherein determining the output data further comprises processing by language model neural network a third input subsequence derived from history data that specifies a previous action performed by the computing device within a previous user interface displayed on the computing device.

18. The system of claim 10, wherein the operations further comprise providing for display on the computing device a result of executing the task in response to receiving the input.

19. The system of claim 10, wherein the language model neural network has been trained on training sequences generated from user interaction with the computing device, and wherein the training comprises updating parameter values of the language model neural network to minimize a loss function that evaluates, for each training sequence, a difference between (i) an action described in training output data determined by the language model neural network from processing the training sequence and (ii) an actual action performed by the user on the computing device.

20. The computer storage media of claim 11, wherein the input comprises a voice input or a text input from a user of the computing device.
